(19) United States
(12) Patent Application Publication
(10) Pub. No.: US 2020/0102471 A1
(43) Pub. Date: Apr. 2, 2020

(54) COMPOSITION AND METHOD FOR COATING POWDERED HYDROPHILIC POLYMERS THAT PROMOTES DISPERSION AND REDUCES CLUMPING OF THE POLYMER WHEN ADDED TO WATER BASED FLUID SYSTEMS

(71) Applicant: ProAction Fluids LLC, Shreveport, LA (US)

(72) Inventors: Nathan R. Hutchings, Shreveport, LA (US); John Paxton Monsour, Shreveport, LA (US); Ryan Humphrey, Shreveport, LA (US)

(21) Appl. No.: 16/148,458

(22) Filed: Oct. 1, 2018

(51) Int. Cl. C09D 171/02; C09D 4/00

(52) U.S. Cl. CPC C09D 171/02; C09D 4/00

(57) ABSTRACT

A composition for a chemical coating includes either (a) a low volatile organic compound (VOC), high flash point, BTEX-free, and at least partially hydrophobic liquid and/or (b) a concentrated solution of polyethylene glycol and/or (c) melted polyethylene glycol; wherein any or all of (a), (b), (c) is mechanically applied as a coating to a hydrophilic polymer powder to reduce clumping of the partially hydrated polymer upon introduction to a water-based fluid, and therefore promote dispersion and ultimately improve hydration. The coating is naturally removed when introduced into the water-based fluid by either hydrophilic-hydrophobic repulsion, emulsification, dissolution, or a combination thereof; and while higher shear rates increase the removal rate of the coating, high shear mixing is not required to remove the coating.

### CROSS REFERENCE TO RELATED APPLICATIONS

Not Applicable.

### STATEMENT REGARDING FEDERALLY SPONSORED RESEARCH OR DEVELOPMENT

Not Applicable

### NAMES OF THE PARTIES TO A JOINT RESEARCH AGREEMENT

Not Applicable.

### BACKGROUND

This disclosure relates to the field of polymers, such as powdered polymers, added to liquids and liquid fluid systems. In such fluids and systems, the introduced polymer is hydrated as part of the mixing process. For solid polymers, such as powdered polymers, it is known in the art to improve the hydration rate of dry/powdered hydrophilic polymers, such as polyacrylamide, xanthan, guar, AMPS copolymers, and the like, involves modifying the surface area (e.g. grinding) or increasing wettability (e.g. surfactants) to increase hydration rate of the powder. In both such cases, the amount of shear required to prevent clumping of the polymer increases substantially because powdered polymers that hydrate too fast in close proximity actually bind together (intertwine) causing clumping and/or formation of “fish eyes”, and therefore reduces the amount of fully hydrated polymer in the fluid system, or correspondingly reduces the efficiency of the mixing and hydration process.

### DETAILED DESCRIPTION

A process and compositions according to one aspect of the present disclosure may be counter intuitive in that adding a hydrophobic and/or soluble coating to the polymer particles that delays the hydration of the polymer particles by a predetermined amount of time actually improves the amount of active polymer in the final fluid system compared to un-coated powdered polymer under the same mixing conditions without increasing the amount of mixing time and can substantially reduce the amount of mixing energy (shear) required to mix the final polymer fluid. Various compositions and mixing techniques will be explained in more detail below.

A composition for a chemical coating comprised of: either (a) a low volatile organic compound (VOC), high flash point, BTEX-free, and at least partially hydrophobic liquid and/or (b) a concentrated solution of polyethylene glycol and/or (c) melted polyethylene glycol. Any or all of (a), (b), (c) may be mechanically applied as a coating to a hydrophilic polymer powder to reduce clumping of the partially hydrated polymer upon introduction to a water-based fluid, and therefore promote dispersion and ultimately improve hydration. The coating may be naturally removed when introduced into the water-based fluid by either hydrophilic-hydrophobic repulsion, emulsification, dissolution, or a combination thereof; and while higher shear rates increase the removal rate of the coating, high shear mixing is not required to remove the coating.

In some embodiments, the coating comprises low VOC, high flash point, BTEX-free (i.e., containing no benzene, toluene, ethyl-benzene, or xylene) plant oils or blends of plant oils, such as canola oil or soybean oil.

In some embodiments, the coating comprises a 20% to 65% solution of Polyethylene Glycol (PEG) with a molecular weight of 1000 or lower.

In some embodiments, the coating comprises 50-100% solution/melt of PEG with a molecular weight of 1000 or higher heated above the melting point of the PEG to liquefy the PEG.

In some embodiments, the coating comprises petroleum distillate (e.g., mineral oil).

In some embodiments, the coating comprises a combination of at least two of: low VOC, high flash point, BTEX-free plant oils or blends of plant oils; 50-100% solution/melt of PEG with a molecular weight of 1000 or higher heated above the melting point of the PEG to liquefy the PEG; 20% to 65% solution of PEG1000 (Polyethylene Glycol (PEG)); and petroleum distillate (mineral oil).

A method of applying a coating to powdered polymer according to another aspect may be performed by operating:

a sprayer;

a nebulizer;

a mister;

a tumbler;

a trommel;

an auger or multiple augers;

a paddle mixer;

a hydraulic or pneumatic venturi;

a sonicator;

or other similar mechanical device; whereby a homogenous coating is applied to the powdered polymer such that the coated polymer does not have “free liquid” and/or the appearance of a slurry.

In some embodiments, the powdered polymer is coated by adding the powdered polymer and a liquid coating composition together in a tumbler comprising at least one of a concrete mixer or a mortar mixer.

Some embodiments further comprise applying energy to the powdered polymer and coating composition to reduce the viscosity of the coating composition prior to, or during, application to promote and/or improve migration of the coating through the powdered polymer.

In some embodiments, the applied energy comprises at least one of heat and acoustic energy.

A method of applying a coating to powdered polymer according to another aspect may comprise applying a coating composition to the powered polymer at a rate and coating concentration chosen to be sufficient to absorb onto the powdered polymer surface but below a threshold such as to create a slurry or emulsion having free liquid.

In some embodiments, the coating comprises soybean oil applied at a concentration of 0.25-5% by weight to a mixture of powdered polymer, the mixture comprising AMPS-acrylic acid copolymer and polyacrylamide.

In some embodiments, the coating comprises melted PEG-1450 held at a temperature of 60° C. (140° F.) and applied at 1 to 15% to a mixture of xanthan powder.

In some embodiments, the coating comprises hydro-treated petroleum distillates (mineral oil) mixed with finely ground polyacrylamide at a concentration of 0.1 to 15%.

In some embodiments, composition of the coating and/or mixtures of the coatings comprise powdered polymers including guar and all guar derivatives, cellulose and all cellulose derivatives, xanthan, polyacrylamide, AMPS and AMPS-copolymers, polyethylene oxides, and the like. The coating can be naturally removed when introduced into the water-based fluid by either hydrophilic-hydrophobic repulsion, emulsification, dissolution, or a combination thereof; and while higher shear rates increase the removal rate of the coating, high shear mixing is not required to remove the coating

A method for using a coated polymer powder that results in a temporary hydration barrier that lasts for a predetermined time in order to allow the coated polymer powder to disperse in a water-based fluid system with minimal clumping thereby preventing the formation of fish-eyes and improving the consistency (smoothness) of the final fluid system, the method comprising, applying the coating comprising soybean oil applied at a concentration of 0.25-5% by weight to a mixture of powdered polymer, the mixture comprising AMPS-acrylic acid copolymer and polyacrylamide the coating applied at 3% by weight resulting in approximately 5 to 15 second hydration delay in fresh water (tap water) at 21.5 C (71 F) when mixed at a shear rate of approximately 200 sec⁻¹.

In some embodiments, surfactants and/or detergents and/or pH modifiers may be added to the fluid system to modify the dispersion rate of the coating and/or modify the amount of shear required to removal rate the coating from the fluid.

Various embodiments of a coating applied to a hydrophilic compound may have as an additional benefit reduced production of dust.

Although only a few examples have been described in detail above, those skilled in the art will readily appreciate that many modifications are possible in the examples. Accordingly, all such modifications are intended to be included within the scope of this disclosure as defined in the following claims.

What is claimed is:

1. A composition for a chemical coating comprised of:
either (a) a low volatile organic compound (VOC), high flash point, BTEX-free, and at least partially hydrophobic liquid and/or
(b) a concentrated solution of polyethylene glycol and/or
(c) melted polyethylene glycol; wherein
any or all of (a), (b), (c) is mechanically applied as a coating to a hydrophilic polymer powder to reduce clumping of the partially hydrated polymer upon introduction to a water-based fluid, and therefore promote dispersion and ultimately improve hydration.

2. The composition of claim 1, wherein the coating comprises low VOC, high flash point, BTEX (benzene, toluene, ethylbenzene and xylene)-free plant oils or blends of plant oils, such as canola oil or soybean oil.

3. The composition of claim 1, wherein the coating comprises a 20% to 65% solution of PEG (Polyethylene Glycol (PEG)) with a molecular weight 1000 or lower.

4. The composition of claim 1, wherein the coating comprises 50-100% solution/melt of PEG with a molecular weight of 1000 or higher heated above the melting point of the PEG to liquefy the PEG.

5. The composition of claim 1, wherein the coating comprises petroleum distillate (mineral oil).

6. The composition of claim 1, wherein the coating comprises a combination of at least two of: low VOC, high flash point, BTEX-free plant oils or blends of plant oils; 50-100% solution/melt of PEG with a molecular weight of 1000 or higher heated above the melting point of the PEG to liquefy the PEG; 20% to 65% solution of PEG1000 (Polyethylene Glycol (PEG)); and petroleum distillate (mineral oil).

7. A method of applying a coating to powdered polymer by operating at least one of a:
a sprayer; a nebulizer; a mister; a tumbler;
a trammel; a paddle mixer; and a sonicator;
whereby a homogenous coating is applied to the powdered polymer such that the coated polymer does not comprise free liquid and/or a slurry.

8. The method of claim 7 wherein the powdered polymer is coated by adding the powdered polymer and a liquid coating composition together in a tumbler comprising at least one of a concrete mixer and a mortar mixer.

9. The method of claim 7 further comprising applying energy to the powdered polymer and coating composition to reduce the viscosity of the coating composition prior to, or during, application to promote and/or improve migration of the coating through the powdered polymer.

10. The method of claim 9 wherein the applied energy comprises at least one of heat and acoustic energy.

11. A method of applying a coating to powdered polymer comprising applying a coating composition to the powered polymer at a rate and coating concentration chosen to be sufficient to absorb onto the powdered polymer surface but below a threshold such as to create a slurry or emulsion having free liquid.

12. The method of claim 11, wherein the coating composition comprises soybean oil applied at a concentration of 0.25-5% by weight to a mixture of powdered polymer, the mixture comprising AMPS-acrylic acid copolymer and polyacrylamide.

13. The method of claim 11 wherein the coating comprises melted PEG-1450 held at a temperature of 60° C. (140° F.) applied at 1 to 15% to a mixture of xanthan powder.

14. The method of claim 11 wherein the coating comprises hydro-treated petroleum distillates (mineral oil) mixed with finely ground polyacrylamide at a concentration of 0.1 to 15%.

15. The method of claim 11 wherein composition of the coatings and/or mixtures of the coatings comprise one or more powdered polymers, including guar and all guar derivatives, cellulose and all cellulose derivatives, xanthan, polyacrylamide, AMPS and AMPS-copolymers and polyethylene oxides.

16. A method for coating polymer powder that results in a temporary hydration barrier that lasts a predetermined time in order to allow the coated powdered material to disperse in a water-based fluid system with minimal clumping thereby preventing the formation of fish-eyes and improving the consistency (smoothness) of the final fluid system, the method comprising: applying the coating comprising soybean oil applied at a concentration of 0.25-5% by weight to a mixture of powdered polymer, the mixture comprising AMPS-acrylic acid copolymer and polyacrylamide the coating applied at 3% by weight resulting in approximately 5 to 15 second hydration delay in fresh water (tap water) at 21.5 C (71 F) when mixed at a shear rate of 200 sec-1.

17. The method of claim 16, wherein the coating applied at 3% by weight resulting in approximately a 5 to 15 second hydration delay in fresh water (tap water) at 21.5 C (71 F) when mixed at a shear rate of approximately 200 sec⁻¹.

18. The method of claim 16, wherein surfactants and/or detergents and/or pH modifiers are added to the fluid system to modify a dispersion rate of the coating and/or modify the amount of shear required to remove the coating from the polymer.
